(19) United States
(12) Patent Application Publication
(10) Pub. No.: US 2017/0085088 A1
(43) Pub. Date: Mar. 23, 2017

(54) ELECTRIC POWER GENERATION OPERATION POINT CONTROL CIRCUIT DEVICE AND MULTI-STAGE ELECTRIC POWER GENERATION OPERATION POINT CONTROL CIRCUIT DEVICE

(71) Applicants: Toyota Jidosha Kabushiki Kaisha, Toyota-shi Aichi-ken (JP); Tokyo Metropolitan University, Tokyo (JP)

(72) Inventors: Shinichi Urabe, Sunto-gun Shizuoka-ken (JP); Toshihisa Shimizu, Fuchu-shi Tokyo (JP)

(21) Appl. No.: 15/267,318

(22) Filed: Sep. 16, 2016

(30) Foreign Application Priority Data
Sep. 18, 2015 (JP) 2015-184852

(51) Int. Cl. H02J 3/38

(52) U.S. Cl. CPC H02J 3/383

(57) ABSTRACT

An electric power generation operation point control circuit device includes: a first capacitor connected in parallel to a photovoltaic cell via the pair of electrode connection terminals between the pair of output terminals; a first switching element connected in parallel to the photovoltaic cell via the pair of electrode connection terminals and the inductor between the pair of output terminals and causing a conduction state or a non-conduction state between the connected terminals; and a second capacitor connected in series to the first capacitor between a first electrode connection terminal and a first output terminal and causing the conduction state or the non-conduction state between the connected terminals.

### CROSS-REFERENCE TO RELATED APPLICATIONS

This application claims priority to Japanese Patent Application No. 2015-184852 filed on Sep. 18, 2015, the entire contents of which are hereby incorporated by reference.

### BACKGROUND OF THE DISCLOSURE

1. Field of the Disclosure

The disclosure relates to an electric power generation operation point control circuit device for a photovoltaic cell and, more particularly, to a device that is configured to control an electric power generation voltage of a photovoltaic cell and to be capable of boosting an output voltage. In addition, the disclosure relates to a multi-stage electric power generation operation point control circuit device.

2. Description of Related Art

As is well known in the field of photovoltaic electric power generation technology, a photovoltaic cell has a characteristic that a current changes as an electric power generation voltage increases from 0 V as is exemplified in FIG. 6A. An optimal operation point is present in generated electric power, and the optimal operation point is an operation state where the generated electric power is at its maximum magnitude. The optimal operation point is referred to as a maximum electric power point or an optimum operation point. In general, operation voltages of various machinery and equipment and chargers do not always correspond to the electric power generation voltage of the photovoltaic cell. Accordingly, when driving of the various machinery and equipment and charging of the charger are executed with an output of the photovoltaic cell, a boosting/step-down mechanism is required for the electric power generation voltage of the photovoltaic cell to be converted to the operation voltages of the machinery and equipment and the charger. Hence, the photovoltaic cell is normally connected to a load such as the various machinery and equipment and charger via a converter circuit such as a boosting circuit and a boosting/step-down circuit when the photovoltaic cell is operated. The converter circuit executes a voltage conversion for an output voltage of the circuit to correspond to the operation voltage of the load while controlling an operation point of the photovoltaic cell such that the electric power generation voltage of the photovoltaic cell becomes a voltage at the maximum electric power point. In general, a boosting chopper circuit or a boosting/step-down chopper circuit is used as the converter circuit for the photovoltaic cell as is exemplified in FIG. 6B and FIG. 6C. In short, a pulse width modulation control is executed in the case of these chopper circuits, the pulse width modulation control being to regulate a duty ratio of switching means such that a boosting/step-down ratio (Vout/Vop) is achieved and a voltage Vout on an output side of the circuit becoming the load operation voltage and an electric power generation voltage Vsi of the photovoltaic cell on an input side of the circuit becoming a voltage Vop at the maximum electric power point at the boosting/step-down ratio (Vout/Vop).

When a boosting function of the chopper circuit described above is insufficient in a case where the electric power generation voltage of one photovoltaic cell is boosted up to a load voltage, a configuration in which a plurality of the photovoltaic cells are connected in series, that is, a photovoltaic cell module, is adopted in some cases. Each case where the term of “boosting” is mentioned in this specification is to refer to performing a voltage conversion for obtaining an output voltage that is higher than an input voltage with a certain voltage being used as the input voltage unless otherwise specified. In the case of a configuration in which the plurality of photovoltaic cells are simply connected in series, however, a light reception amount might vary from cell to cell due to a shadow or the like generated on some of the cells. In this case, the current at the maximum electric power point might vary from cell to cell (refer to FIG. 6A). When the same current flows through all the cells connected in series nonetheless, a state where an operation at the maximum electric power point is not achieved arises in some of the cells and an output of the photovoltaic cell module might drop. In this case, the cell with a smaller electric power generation amount acts as a reverse-bias diode and becomes resistance, and thus an electric power loss ensues as well. In this regard, electric power generation operation point control circuit devices that are capable of individually controlling the respective operation points of the photovoltaic cells which are connected in series as is exemplified in FIG. 7A have been proposed in the following three patent documents as devices for avoiding the decline in output that is attributable to the variation in light reception amount of the photovoltaic cells in the configuration in which the plurality of photovoltaic cells are connected in series.

Toshihisa Shimizu and six others, Solar/Wind Power Energy Lecture Paper, 1996, pages 57 to 60

Toshihisa Shimizu, FB Technical News No. 56, Nov. 1, 2000, pages 22 to 27

Toshihisa Shimizu and three others, “Generation Control Circuit for Photovoltaic Modules” IEEE TRANSACTIONS ON POWER ELECTRONICS, VOL. 16, NO. 3, MAY 2001, pages 293 to 300

The electric power generation operation point control circuit device controls the electric power generation voltage, by using a multi-stage boosting chopper circuit with respect to the circuit configuration in which the plurality of photovoltaic cells are connected in series, such that the currents at the respective maximum electric power points flow through the photovoltaic cells. Then, all the photovoltaic cells can perform electric power generation substantially at the maximum electric power points. In the case of the electric power generation operation point control circuit devices disclosed in the three patent documents described above, the output voltage Vout becomes the total sum of the voltages at the respective maximum electric power points of the plurality of photovoltaic cells. Accordingly, the converter circuit as described above is still used additionally when the photovoltaic cell module is connected to the load.

### SUMMARY

In the converter circuit such as the boosting chopper circuit and the boosting/step-down chopper circuit that is used as the electric power generation operation point control circuit device which has the boosting function so that an output voltage corresponding to the load operation voltage is obtained by the electric power generation voltage of the photovoltaic cell in particular being boosted while the control of the operation point of the photovoltaic cell being executed, it is preferable that a loss which is attributable to an operation of the converter circuit is kept at its minimum. For example, if available, a circuit configuration that is capable of further reducing the electric power loss in a semiconductor device which is used in the switching means is more advantageous than the circuits exemplified in FIG. 6B and FIG. 6C. In addition, in a case where the load voltage is to be obtained by output voltage boosting with regard to the electric power generation operation point control circuit device configured for the plurality of photovoltaic cells to be connected in series, the converter circuit is connected to the electric power generation operation point control circuit device as described above. In this case, the total sum of the electric power generation voltages of the photovoltaic cells or the output voltage resulting from additional boosting thereof is applied to the switching means, an inductor, or the like in the converter circuit. Accordingly, an element that is capable of withstanding the total sum of the electric power generation voltages of the photovoltaic cells or the output voltage resulting from the additional boosting thereof needs to be prepared and the losses in the switching means, the inductor, or the like in the converter circuit might also increase. Hence, if available, a circuit configuration that is capable of reducing the loss more than in the case of the chopper circuit connection to the electric power generation operation point control circuit device is advantageous even in the case of the photovoltaic cells connected in series.

The disclosure provides a configuration that is capable of reducing a loss which is generated in, for example, switching means such as a semiconductor device in an electric power generation operation point control circuit device for a photovoltaic cell that has a boosting function.

In addition, the disclosure provides a configuration that allows each photovoltaic cell to perform electric power generation substantially at its maximum electric power point, has a boosting function, and is capable of reducing losses which are generated in switching means and an inductor in an electric power generation operation point control circuit device for a photovoltaic cell module that has a configuration in which a plurality of the photovoltaic cells are connected in series.

A first aspect of the disclosure is an electric power generation operation point control circuit device including: a pair of output terminals; a pair of electrode connection terminals connected to an electrode terminal of a photovoltaic cell between the pair of output terminals; a first capacitor connected in parallel to the photovoltaic cell via the pair of electrode connection terminals between the pair of output terminals; an inductor; a first switching element connected in parallel to the photovoltaic cell via the pair of electrode connection terminals and the inductor between the pair of output terminals and causing a conduction state or a non-conduction state between the connected terminals; a second capacitor connected in series to the first capacitor between a first electrode connection terminal and a first output terminal and causing the conduction state or the non-conduction state between the connected terminals, the first electrode connection terminal being one of the pair of electrode connection terminals and the first output terminal being one of the output terminals; a second switching element connected in parallel to the second capacitor and connected in series to the first switching element; and a calculation device configured to control the first switching element and the second switching element in an alternating manner at a predetermined cycle such that the second switching element is put into the non-conduction state when the first switching element is in the conduction state and the second switching element is put into the conduction state when the first switching element is in the non-conduction state.

According to the aspect described above, the presence of a circuit part that is formed by the additional capacitor and the switching means allows a boosting function to cause the output voltage between the pair of output terminals to become higher in value than the electric power generation voltage of the photovoltaic cell to be achieved. In addition, the applied voltages of the switching means and the additional switching means that are used for the circuit can be lower than in the converter circuit configuration according to the related art.

A second aspect of the disclosure is a multi-stage electric power generation operation point control circuit device, wherein the electric power generation operation point control circuit device as described above is connected in series to the output terminal.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1A is an exemplary circuit configuration diagram of an embodiment of an electric power generation operation point control circuit device according to an aspect of the disclosure;

FIG. 1B is a diagram illustrating an exemplary time chart of an ON state and an OFF state of switching means;

FIG. 1C is an exemplary circuit configuration diagram of an embodiment of the electric power generation operation point control circuit device according to the aspect of the disclosure showing an example in which an ammeter and a voltmeter are disposed;

FIG. 1D is an exemplary circuit configuration diagram of an embodiment of the electric power generation operation point control circuit device according to the aspect of the disclosure showing an example in which a plurality of photovoltaic cells are connected in parallel;

FIG. 2A is a diagram illustrating a current flow at a time when the switching means M2 is in the OFF state in the circuit configuration that is illustrated in FIG. 1A, the dotted-line arrows showing current flow directions;

FIG. 2B is a diagram illustrating a current flow at a time when the switching means M1 is in the OFF state in the circuit configuration that is illustrated in FIG. 1A, the dotted-line arrows showing current flow directions;

FIG. 3 is a circuit configuration diagram of a multi-stage electric power generation operation point control circuit device that is formed by a plurality of the electric power generation operation point control circuit devices being connected in series, the electric power generation operation point control circuit device being exemplified in FIG. 1A;

FIG. 4 is a diagram schematically illustrating an MPPT control circuit device in a case where a switching means control is executed by a single MPPT control circuit in the multi-stage electric power generation operation point control circuit device that is illustrated in FIG. 3;

FIG. 5 is an exemplary circuit configuration diagram illustrating a case where switching means for safety management (external response switching means) is disposed between the unit electric power generation operation point control circuit devices in the multi-stage electric power generation operation point control circuit device that is illustrated in FIG. 3;

FIG. 6A is a characteristic diagram schematically showing changes in an electric power generation current and generated electric power with respect to an electric power generation voltage of the photovoltaic cell;

FIG. 6B is a diagram illustrating an example of a circuit configuration of a boosting chopper circuit that is used as an electric power generation operation point control circuit device according to the related art;

FIG. 6C is a diagram illustrating an example of a circuit configuration of a boosting/step-down chopper circuit that is used as the electric power generation operation point control circuit device according to the related art;

FIG. 7A is a diagram illustrating an example of a circuit configuration of an electric power generation operation point control circuit device according to the related art for a photovoltaic cell module that is formed by a plurality of photovoltaic cells which are connected in series; and

FIG. 7B is a diagram illustrating an exemplary time chart of an ON state and an OFF state of switching means.

### DETAILED DESCRIPTION OF EMBODIMENTS

Hereinafter, several embodiments of the disclosure will be described in detail with reference to accompanying drawings. In the drawings, the same reference numerals will be used to refer to the same regions.

Configuration Of Electric Power Generation Operation Point Control Circuit Device (Unit)

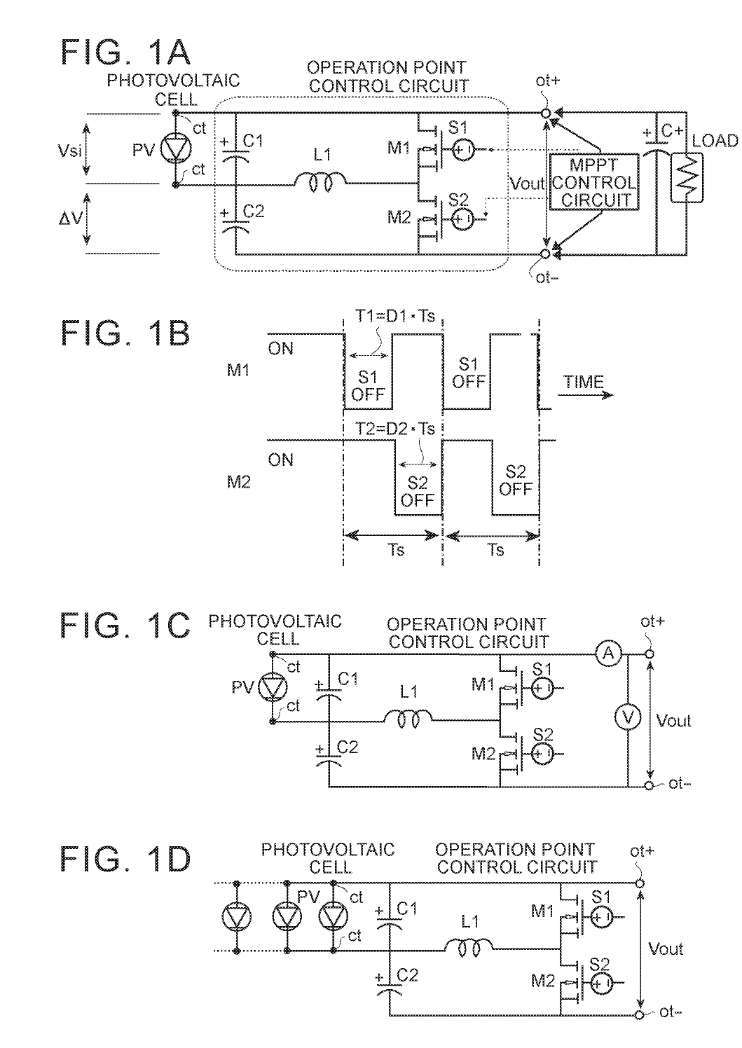

Referring to FIG. 1A, a capacitor C1 and switching means M1 are connected in parallel with respect to a photovoltaic cell PV between output terminals ot+, ot− that constitute a circuit of an electric power generation operation point control circuit device for the photovoltaic cell according to the disclosure. In addition, a capacitor C2 is added in series with respect to the capacitor C1 and switching means M2 is added with respect to the switching means M1 in the circuit that is formed by connection between the capacitor C1 and the switching means M1 via an inductor L1. It can be said that this configuration is a two-stage boosting chopper circuit configuration in which a boosting chopper circuit that is formed by the capacitor C1, the switching means M1, and the inductor L1 (configuration excluding switching means on the output terminal side, the same applies hereinbelow) and a boosting chopper circuit that is formed by the capacitor C2, the switching means M2, and the inductor L1 are connected in series between the output terminals ot+, ot−. The photovoltaic cell PV that is connected between terminals ct, ct may be a single photovoltaic cell. Alternatively, the photovoltaic cell PV that is connected between the terminals ct, ct may be a plurality of photovoltaic cells that are connected in series in a case where an unevenness in light reception amount on the photovoltaic cells connected in series which is attributable to a shadow or the like is within an allowable range even if a certain quantity of the photovoltaic cells are connected in series. In addition, the switching means M1, M2 may typically be switching means such as MOSFETs that are used in an electric power generation operation point control circuit device for a normal photovoltaic cell. The switching means M7, M2 have control inputs S1, S2, respectively. The switching means M1, M2 selectively perform conduction and cut-off between upper and lower terminals illustrated in the drawing, that is, between terminals at both ends of the corresponding photovoltaic cell PV and capacitors C1, C2 connected in parallel in response to inputs of the control inputs S1, S2 in a manner which will be described later. The capacitor and the inductor may be any capacitor and inductor that are in common use in this field.

In a case where the electric power generation operation point control circuit device described above is actually used, a load such as any machinery and equipment, device, and charger is connected and an MPPT control circuit that controls a voltage Vout between the output terminals or any other voltage/current controller (hereinafter, simply referred to as a “voltage/current controller”) is connected between the output terminals ot+, ot−. The voltage/current controller is configured to hold an output voltage between the output terminals at a voltage required for the load or a desired voltage and give the control inputs S1, S2 a control signal for the selective conduction and cut-off so that an electric power generation voltage of the photovoltaic cell PV is regulated. The voltage/current controller may be a circuit or a controller that has any type of configuration which is known in the field of photovoltaic cell electric power generation control. In addition, the load may be connected via the voltage/current controller. Alternatively, the load may be one that has a significant voltage between input terminals of itself, examples of which include a rechargeable battery. In this case, the function to hold the voltage between the output terminals ot+, ot− may not be executed by the controller. In other words, in the circuit configuration according to the disclosure, a significant voltage (output voltage) may be generated with some sort of technique between load-connected terminals further on the output side than the switching means M1, M2. Any voltage is set as this output voltage and, typically, this output voltage is set to be equal to a load operation voltage. Normally, a smoothing capacitor C+ that is connected in parallel with respect to the load and is used for output voltage smoothing is connected as illustrated in FIG. 1A. A function of the smoothing capacitor C+ may be achieved in the voltage/current controller (it may be conceivable that the smoothing capacitor C+ is disposed in the voltage/current controller).

Operation of Electric Power Generation Operation Point Control Circuit Device

(1) Electric Power Generation Operation Point Control in Case where Converter Circuit According to Related Art is Used

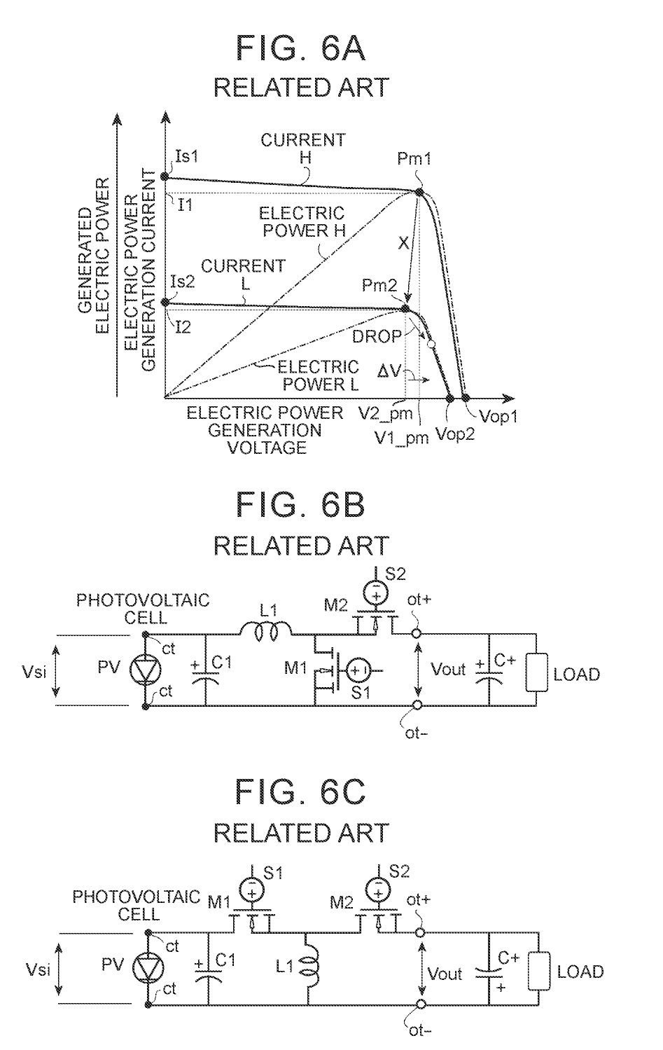

Referring to FIG. 6A, the photovoltaic cell as described above generally has a characteristic that its current (solid line) changes with respect to the electric power generation voltage as illustrated in the drawing. A maximum electric power point (Pm1, Pm2), at which electric power is maximized, is present in a change in generated electric power (one-dot chain line) of the photovoltaic cell. These current-voltage and electric power-voltage characteristics of the photovoltaic cell change depending on an environmental condition of the photovoltaic cell. When the light reception amount is reduced due to the shadow or the like, a phenomenon occurs such as a phenomenon in which the characteristic curve illustrated in the form of the electric power H in the drawing is turned into the characteristic curve illustrated in the form of the electric power L in the drawing as a result of the characteristic curve illustrated in the form of the current H in the drawing being turned in a current-dropping direction into the characteristic curve illustrated in the form of the current L in the drawing. Accordingly, in a case where the electric power generation of the photovoltaic cell is executed, the electric power generation voltage of the photovoltaic cell may be controlled such that an operation point of the photovoltaic cell becomes the maximum electric power point (electric power generation operation point control).

Converter circuits as exemplified in FIG. 6B and FIG. 6C are used for this electric power generation operation point control to be executed. In these circuits, the control signal (ON/OFF) is given to the control inputs S1, S2 of the switching means M1, M2 so that these switching means execute the conduction and cut-off in an alternating manner, that is, so that a chopper operation is executed by these switching means. In this manner, the voltage of the photovoltaic cell PV is regulated (refer to FIG. 1B). In the case of the circuit that is illustrated in FIG. 6B, for example, the following relationship is satisfied between the voltage Vout between the output terminals [ot+, ot−] and a voltage Vsi between the terminals [ct, ct] to which the photovoltaic cell PV is connected by an OFF time duty ratio D (hereinafter, simply referred to as a “duty ratio”) being used, the duty ratio being the ratio of a time width of an OFF state to a predetermined cycle Ts of the switching means M1.

Vsi=D·Vout (1)

In other words, regulation of the duty ratio D for Vsi to become an electric power generation voltage Vop at the maximum electric power point of the photovoltaic cell PV at a time when the output voltage Vout, which is the output voltage of the load, is a certain value allows driving or charging of the load to be achieved in a state where an output of the photovoltaic cell PV is maximized (which is substantially the same as in the case of FIG. 6C). In addition, because Vout is equal to or higher than Vsi, the operation point of the photovoltaic cell is regulated by the converter circuit and boosting is achieved. In the example that is illustrated in the drawing, the switching means M2 is turned OFF, that is, is put into a cut-off state, so that the conduction between the load and the photovoltaic cell is cut off, when the switching means M1 is turned ON, that is, is in a conduction state. In the example that is illustrated in the drawing, the switching means M2 is turned ON, for the conduction between the load and the photovoltaic cell, when the switching means M1 is turned OFF. This switching means M2 can be achieved with a diode element as well, and thus the diode element is adopted in the switching means M2 in some cases.

In the case of the above-described converter circuits that are illustrated in FIG. 6B and FIG. 6C, the output voltage Vout is applied during the chopper operation to the switching means M1, M2 in particular, and thus a loss resulting from the output voltage Vout occurs in the switching means M1, M2 and allowable withstand voltages of the switching means M1, M2 need to be higher than the output voltage Vout.

(2) Control of Electric Power Generation Operation Point Control Device According to Aspect of Disclosure

Referring to FIG. 1A and FIG. 1B, during a control of an electric power generation operation point control device according to an aspect of the disclosure, the switching means M1, M2 connected in series between the output terminals are controlled such that the conduction and cut-off are executed in an alternating manner at the predetermined cycle Ts as schematically illustrated in FIG. 1B in accordance with the control inputs S1, S2 from the voltage/current controller as is the case with the converter circuit according to the related art. In this configuration, the output voltage Vout, the voltage Vsi of the photovoltaic cell PV, and a voltage ΔV of the capacitor C2 satisfy the following relationship by using OFF time duty ratios D1, D2 that are the ratios of the time width of the OFF state to the predetermined cycle Ts of the switching means M1, M2.

Vout=Vsi+ΔV (2a)

Vsi=D1·Vout (2b)

ΔV=D2·Vout (2c)

D1+D2=1 (2d)

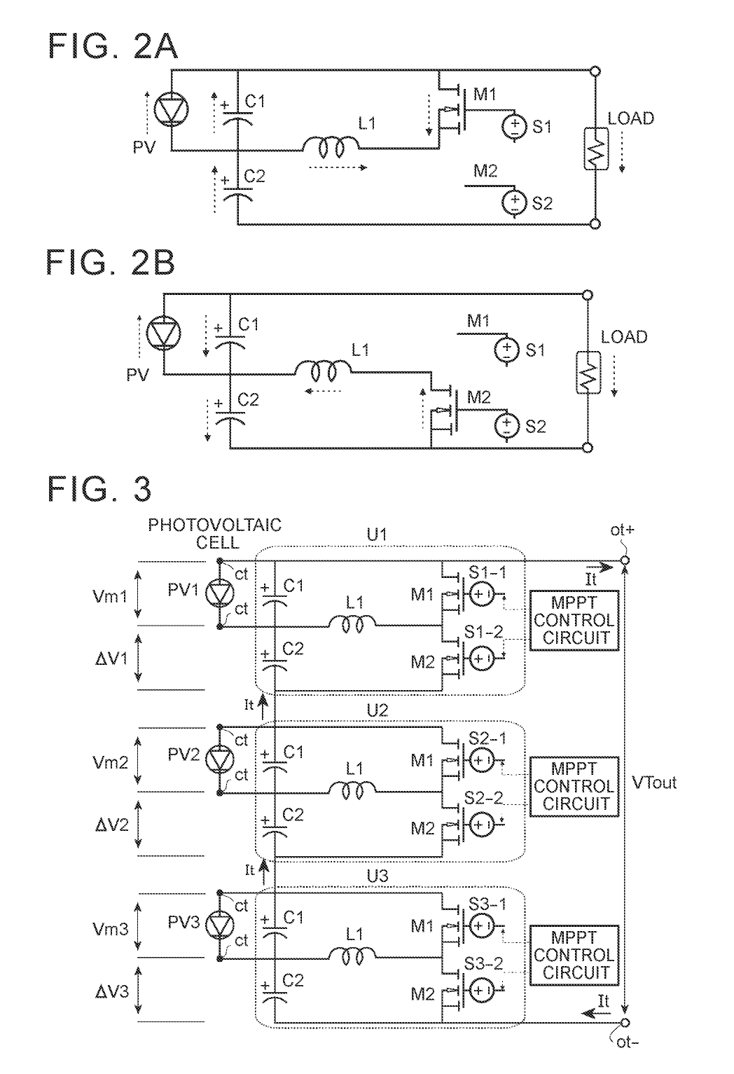

In other words, the duty ratios D1, D2 are the ratio of the electric power generation voltage of the photovoltaic cell to the output voltage (Vsi/Vout) and the ratio of a voltage difference obtained by the electric power generation voltage of the photovoltaic cell being subtracted from the output voltage between a pair of the output terminals to the output voltage (ΔV/Vout), respectively. In the configuration described above, an electric charge for the capacitor C2 to hold ΔV is given by a current inflow from the inductor in a process of switching means ON/OFF state change. Referring to FIG. 2, in the capacitor C2, the current flows in from the inductor of another stage when a corresponding switch element is in an ON state and the current flows out from the capacitor C2 when the corresponding switch element is in an OFF state regarding the current flow during a switching means operation. At this time, the output voltage is held at Vout, and thus the voltage of the capacitor C2 in time average becomes a voltage obtained by the total sum of photovoltaic cell electric power generation voltages being subtracted from the output voltage Vout as is shown in the equation above.

In the electric power generation operation point control circuit device according to the disclosure described above, Vout, D1, D2 can be set to any values within ranges of allowable limits of the respective elements. Accordingly, Vsi can be set to become any voltage within a range allowed in the photovoltaic cell with respect to the certain load operation voltage Vout by D1, D2 being regulated and the electric power generation voltage of the photovoltaic cell can be boosted to the operation voltage of the load in the state where the output of the photovoltaic cell PV is maximized by DE D2 being regulated such that Vsi becomes the electric power generation voltage Vop at the maximum electric power point of the photovoltaic cell. Regarding actual setting of the values of D1, D2 in the circuit described above, the generated electric power is measured by the voltage and the current between the output terminals being monitored during a change in the values of D1, D2 in a state where Vout that has any value is held by the voltage/current controller (such as the MPPT control circuit) or the like and conditions of DE D2 giving maximum electric power are searched for and used. Accordingly, a voltmeter that monitors the voltage between the output terminals and an ammeter that monitors the current between the output terminals may be disposed as illustrated in FIG. 1C (the voltage and the current between the output terminals may be monitored in the voltage/current controller). In addition, when the maximum electric power point of the photovoltaic cell has changed due to a change in environment or the like, the conditions of D1, D2 giving the maximum electric power are searched for again and updated in the voltage/current controller. Typically, the search for and update of the conditions of D1, D2 giving the maximum electric power may be executed at, for example, any cycle.

In the case of the circuit configuration according to the disclosure that is exemplified in FIG. 1A, the output voltage Vout is distributed to the switching means M1, M2 as is apparent in the drawing and the applied voltages become Vsi (=Vop) and ΔV, respectively. Each of Vsi (=Vop) and ΔV is lower in value than the output voltage Vout. Accordingly, in a case where the operation point control and boosting of the electric power generation voltage of the same photovoltaic cell are executed at the same load voltage by the device according to the disclosure and the converter circuit according to the related art, the voltage applied to the switching means M1, M2 of the device according to the disclosure is relatively lower than in the case of the converter circuit according to the related art. Hence, in the case of the device according to the disclosure, the loss in the switching means M1, M2 is reduced compared to the related art and the allowable withstand voltage required for the switching means M1, M2 is also reduced compared to the related art.

Referring back to FIG. 6A, the electric power generation voltage changes relatively less significantly in general, although a current value at the maximum electric power point changes to a significant extent, in a case where, for example, the maximum electric power point changes from Pm1 to Pm2 in the single photovoltaic cell as is shown by the arrow X in the drawing. In the device according to the disclosure described above, the electric power generation voltage of the photovoltaic cell is controlled in this regard, and thus an electric power generation operation is achieved substantially at the maximum electric power point for each of a plurality of the photovoltaic cells connected in parallel between the terminals [ct, ct] to which the photovoltaic cells PV are connected even if the plurality of photovoltaic cells are connected in parallel between the terminals [ct, ct] to which the photovoltaic cells PV are connected unless the electric power generation voltage at the maximum electric power point of the photovoltaic cell changes to a significant extent. Accordingly, in the device according to the disclosure described above, the plurality of photovoltaic cells may be connected in parallel between the terminals [ct, ct] as is exemplified in FIG. 1D. In this case, the output voltage changes little and an output current can be increased.

Configuration and Operation of Multi-Stage Electric Power Generation Operation Point Control Circuit Device

A plurality of the electric power generation operation point control circuit devices according to the disclosure may be connected in series to constitute a multi-stage electric power generation operation point control circuit device as illustrated in FIG. 3, the electric power generation operation point control circuit device having been described with reference to FIG. 1A. Even in this case, the output voltage at both ends of the multi-stage electric power generation operation point control circuit device can be set to any voltage that is higher than the total sum of the electric power generation voltages of the photovoltaic cells in a state where all the photovoltaic cells are operated at the maximum electric power points. In other words, according to the configuration described above, all the photovoltaic cells can be operated at the respective maximum electric power points and then the output voltages can be boosted such that the output voltages correspond to any load voltage, even if the maximum electric power points of the photovoltaic cells differ from each other, in a case where the plurality of photovoltaic cells are to be used in series.

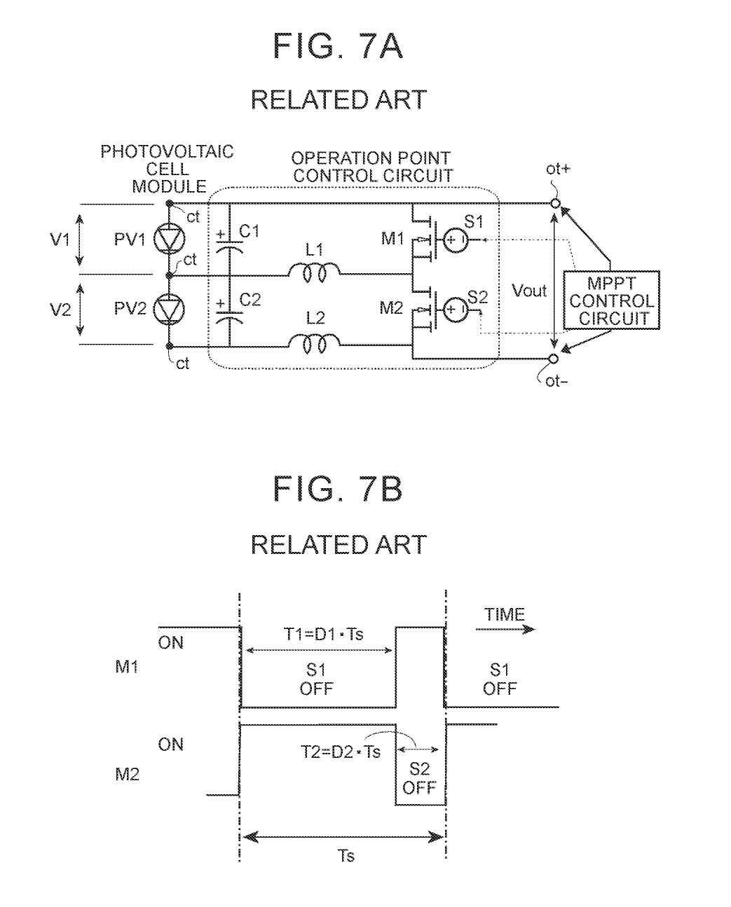

In a case where the photovoltaic cells are connected in series as described above, a deviation might occur between current-voltage characteristic curves of the photovoltaic cells due to, for example, some of the photovoltaic cells being put into a shade. Then, a difference arises between the currents at the maximum electric power points. Then, some of the photovoltaic cells become incapable of electric power generation at the maximum electric power point in the case of a configuration in which the same current flows through the photovoltaic cells that are connected in series. Then, the electric power that is obtained in this state falls below the maximum electric power that is to be obtained in accordance with the light reception amount of all the photovoltaic cells. Suggested in the related art in this regard is regulation of the electric power generation voltage and current by photovoltaic cell by an electric power generation operation point control circuit device in which a boosting chopper circuit is connected to each photovoltaic cell as is exemplified in, for example, FIG. 7A for all the photovoltaic cells to perform the electric power generation operation at the respective maximum electric power points.

In short, during an operation of the electric power generation operation point control circuit device that is exemplified in FIG. 7A, the switching means M1, M2 are controlled such that switching between the ON state and the OFF state is performed on the switching means M1, M2 at the predetermined cycle Ts and either the switching means M1 or the switching means M2 is put into the OFF state and the other one of the switching means M1, M2 is put into the ON state (the same as in the case of FIG. 1B) as is exemplified in FIG. 7B. In this case, the following relationship is satisfied between the voltages V1, V2 of the photovoltaic cells and the output voltage Vout in the boosting chopper circuit by the duty ratios D1, D2 of the switching means being used as illustrated in the drawing.

Vout=V1+V2 (3a)

V1=D1·Vout (3b)

V2=D2·Vout (3c)

In other words, D1+D2 becomes equal to one. Since Vout, D1, D2 can be set to any values within the ranges of the allowable limits of the respective elements, each of the photovoltaic cells is allowed to perform the electric power generation at the electric power generation voltage at the maximum electric power point and the maximum electric power that is to be obtained in accordance with the light reception amount of all the photovoltaic cells is obtained once the duty ratios D1, D2 are regulated to satisfy

D1=V1_pm/Vout (4b)

D2=V2_pm/Vout (4c)

when the output voltage Vout is equal to the total sum of the electric power generation voltages at the maximum electric power points of all the photovoltaic cells, that is, when

Vout=V1_pm+V2_pm (4a)

is satisfied (each of V1_pm and V2_pm being the electric power generation voltage at the maximum electric power point of the photovoltaic cell).

In the case of the above-described electric power generation operation point control circuit device that is illustrated in FIG. 7A, Equations (3a) to (3c) are satisfied even in a case where the output voltage Vout exceeds the total sum of the electric power generation voltages at the maximum electric power points of all the photovoltaic cells, that is, even when

Vout=V1_pm+V2_pm+ΔV (5a)

is satisfied. Accordingly, when, for example, Equation (4b) is satisfied, that is, when

V1=V1_pm=D1·Vout (5b)

is satisfied, V2 is determined as follows.

V2=V2_pm+ΔV=D2·Vout (5c)

In other words, in this case, the electric power generation voltage of the photovoltaic cell PV2 deviates from the electric power generation voltage V2_pm at the maximum electric power point. Then, the generated electric power of the photovoltaic cell PV2 is reduced (the operation point changes from the black-point position to the white-point position) compared to the case of the maximum electric power point because of the deviation ΔV of V2 as is apparent with reference to, for example, the characteristic curve electric power L that is illustrated in FIG. 6A. In other words, in a configuration in which the photovoltaic cell is connected to each boosting chopper circuit as in FIG. 7A, additional converter circuit connection as a booster as exemplified in FIG. 6B and FIG. 6C is required between the output terminals ot+, ot− for the maximum electric power to be obtained in accordance with the light reception amount with all the photovoltaic cells being allowed to perform the electric power generation at the maximum electric power points when required output electric power exceeds the total sum of the electric power generation voltages at the maximum electric power points of all the photovoltaic cells. It should be noted that the above description is applied in a similar manner even when the number of the photovoltaic cells connected in series is three or more.

Meanwhile, in the multi-stage electric power generation operation point control circuit device (hereinafter, referred to as a “multi-stage device”) according to the disclosure that is illustrated in FIG. 3, all the photovoltaic cells can be operated at the respective maximum electric power points and then the output voltages at both ends of the plurality of photovoltaic cells connected in series can be boosted such that the output voltages correspond to any load voltage, even if the maximum electric power points of the plurality of photovoltaic cells connected in series differ from each other, as described above by this multi-stage device alone.

In each of the unit electric power generation operation point control circuit devices (U1 to U3, hereinafter, simply referred to as “units”) of the multi-stage device that is illustrated in FIG. 3, an output voltage VTout between the output terminals can be set to any voltage that is higher than the electric power generation voltage of the photovoltaic cell in the state where the photovoltaic cell is operated at the maximum electric power point as described above. In other words, in a case where a certain output voltage Vouti is set between the output terminals in each of the units of the multi-stage device, the duty ratio can be set in the respective units such that a boosting ratio allows the electric power generation voltage of the photovoltaic cell to become the set output voltage Vouti with respect to the voltage at the maximum electric power point as described in association with the configuration which is illustrated in FIG. 1A.

The output voltage VTout of the multi-stage device is as follows.

VTout=Vout1+Vout2+ . . . (6)

The output voltages of the respective units of the multi-stage device may differ from each other, but the output voltages of the respective units of the multi-stage device have a common current flowing between the units and a common current It between the output terminals. In addition, electric power Pi that is output from each of the units is determined based on the light reception amount of each photovoltaic cell or the like.

Accordingly, output electric power PT of the multi-stage device is given by

PTout=P1+P2+ . . . (7)

and the current It between the output terminals and between the units is determined as follows.

It=PTout/VTout (8)

After the current It between the units is determined, the output voltage Vouti of each unit is assigned as follows.

Vouti=Pint (9)

Accordingly, in each of the units, the electric power generation voltage of the photovoltaic cell can be regulated as desired with respect to the assigned output voltage

Vouti based on the setting of the duty ratio as described above, and thus all the photovoltaic cells can be operated at the respective maximum electric power points and the output voltages at both ends can be boosted such that the output voltages correspond to any load voltage in the plurality of photovoltaic cells connected in series as described above. Regarding actual setting of the values of D1, D2 of each of the units in the circuit configuration illustrated in FIG. 3, the generated electric power is also measured by the voltage and the current between the output terminals being monitored during a change in the values of D1, D2 of each unit in a state where the output voltage VTout of the multi-stage device is held and conditions of D1, D2 of the respective units giving the maximum electric power are searched for and used. Likewise, when the maximum electric power point of the photovoltaic cell has changed due to a change in environment or the like, the conditions of D1, D2 of the respective units giving the maximum electric power are searched for again and updated in the voltage/current controller. Typically, the search for and update of the conditions of D1, D2 giving the maximum electric power may be executed at, for example, any cycle.

Comparing the multi-stage device according to the disclosure that is exemplified in FIG. 3 to a case where an additional converter circuit is connected (not illustrated) to the electric power generation operation point control circuit device according to the related art that is exemplified in FIG. 7A, the total sum of the electric power generation voltages of the photovoltaic cells is applied to an input side of a booster which is connected to the electric power generation operation point control circuit device in the case of the electric power generation operation point control circuit device according to the related art, and thus losses occur in the switching means and the inductor in the booster in response to the applied voltage and allowable withstand voltages of these means need to be higher than the total sum of the electric power generation voltages of the photovoltaic cells and the output voltage of the booster. In contrast, in the case of the multi-stage device according to the disclosure, each of the applied voltages of the switching means M1, M2 and the inductors of the respective units becomes a voltage resulting from additional distribution of the output voltage Vouti distributed to the respective units from the output voltage VTout of the multi-stage device as described above, and thus the losses occurring in the switching means and the inductor of the booster of the electric power generation operation point control circuit device according to the related art do not occur in the multi-stage device according to the disclosure and the multi-stage device according to the disclosure is advantageous in that the allowable withstand voltages required for the switching means and the inductor of the booster of the electric power generation operation point control circuit device according to the related art do not have to be prepared. Regarding the regulation of the duty ratio of the switching means incorporated into the device, in addition, the case of the electric power generation operation point control circuit device according to the related art that is exemplified in FIG. 7A entails a somewhat more complex regulation processing because the duty ratio of the switching means connected in parallel in each photovoltaic cell is regulated in view of the electric power generation voltages of all the photovoltaic cells and the duty ratio of the switching means of the booster is regulated in view of an input/output voltage whereas the case of the multi-stage device according to the disclosure that is exemplified in FIG. 3 is expected to entail an easier regulation processing because the duty ratio of the switching means is regulated by unit once the assignment of the output voltage of each unit is determined based on the electric power generated by each unit.

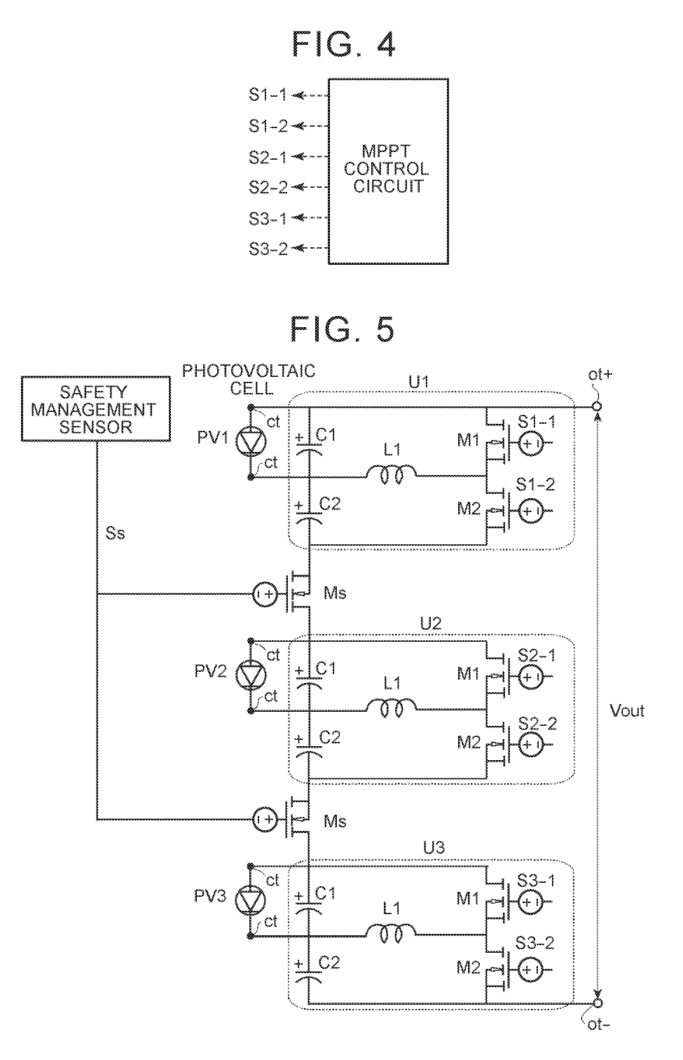

In the circuit configuration that is drawn in FIG. 3, the voltage/current controller (such as the MPPT control circuit), which is means for controlling the switching means, is disposed for each of the units. However, the control of the switching means of all the units may also be executed in an integrated manner by a single voltage/current controller as is schematically drawn in FIG. 4.

Multi-Stage Electric Power Generation Operation Point Control Circuit Device Provided with External Response Switching Means

As is drawn in FIG. 5, a conducting wire for inter-unit connection in the multi-stage electric power generation operation point control circuit device as exemplified in FIG. 3 may be charged with switching means (external response switching means) Ms, conduction and cut-off of the switching means (external response switching means) Ms being controlled by a signal Ss from the outside. The signal from the outside may be a signal for cutting off the conduction between the units in response to a signal from a sensor (safety management sensor) that detects the occurrence of a state where the electric power generation of the photovoltaic cell should be urgently stopped for safety such as a fire alarm and a collision detection sensor of a facility or a vehicle where the multi-stage device is equipped or mounted. In the case of the photovoltaic cell, electric power is output, even in the event of the occurrence of any accident or the like in the facility or the vehicle, insofar as the photovoltaic cell is free from damage and has received light. In this case, electric leakage or the like might occur once, for example, water is discharged for a fire to be extinguished and the water reaches a device of an electrical system that is connected to the photovoltaic cell. In the case of the multi-stage device in particular, the photovoltaic cells are connected in series, and thus the output voltage thereof is relatively high and a situation in which a trouble attributable to electric leakage or the like becomes severe might arise. In this regard, at a time when the state where the electric power generation of the photovoltaic cell should be urgently stopped for safety reasons occurs, the occurrence of the state may be detected by the safety management sensor and the switching means Ms may cut off the conduction based on information on the state as is exemplified in FIG. 5. According to this configuration, the photovoltaic cell group in which the switching means Ms are connected in series is divided in response to the signal Ss from the safety management sensor and the generation of a high voltage that occurs in a case where the photovoltaic cells are connected in series can be promptly stopped even if each of the photovoltaic cells continues to perform the electric power generation. The switching means Ms with which the inter-unit conducting wire is charged with may be switching means such as a MOSFET in common use in this field. The signal Ss from the outside may be any signal for determining whether or not the electric power generation operation can be performed by the photovoltaic cell based on various other factors as well as the safety management sensor described above.

Typically, the “photovoltaic cell” is the photovoltaic cell. In the case where the unevenness in light reception amount on the photovoltaic cells connected in series which is attributable to the shadow or the like is within the allowable range even if a certain quantity of the photovoltaic cells are connected in series, however, the “photovoltaic cell” may also be the plurality of photovoltaic cells connected in series, examples of the case including a case where the single photovoltaic cell is small in dimension (hereinafter, each case where the “photovoltaic cell” is mentioned may be to refer to either the single photovoltaic cell or a photovoltaic cell module or array that is formed by the plurality of photovoltaic cells being connected in series or in parallel). Each of the switching means, the capacitor, and the inductor may be an element for a circuit in common use in this field.

Basically, in the aspect of the disclosure, an additional capacitor and additional switching means are configured to be respectively connected in series to the capacitor and the switching means in a configuration in which the boosting chopper circuit is connected to the photovoltaic cell (in this case, the configuration does not include the switching means M2 on the output side in FIG. 6B) as will be readily understood from the following description with reference to drawings. In other words, the circuit configuration according to the disclosure is the two-stage boosting chopper circuit in which the boosting chopper circuit to which the photovoltaic cell is not connected is connected in series to the configuration in which the boosting chopper circuit is connected to the photovoltaic cell between the output terminals. The switching means and the additional switching means are operated such that the conduction and cut-off between the terminals to which the switching means and the additional switching means are respectively connected are repeated at the same predetermined cycle and either the switching means or the additional switching means cuts off the inter-terminal conduction when the other performs the inter-terminal conduction.

According to the aspect of the disclosure, the presence of a circuit part that is formed by the additional capacitor and the switching means allows a boosting function to cause the output voltage between the pair of output terminals to become higher in value than the electric power generation voltage of the photovoltaic cell to be achieved. In addition, according to the aspect of the disclosure, the applied voltages of the switching means and the additional switching means that are used for the circuit can be lower than in the converter circuit configuration according to the related art.

In general, the electric power generation voltage of the photovoltaic cell changes in line with the current (refer to FIG. 6A). Accordingly, in a case where the electric power generation voltage of the photovoltaic cell is regulated in the converter circuit according to the related art, the electric power generation voltage of the photovoltaic cell is determined as is exemplified in FIG. 6B and FIG. 6C by the voltage of the load connected between the pair of output terminals (becoming a voltage of the rechargeable battery, a voltage of an MPPT controller executing maximum electric power point tracking (maximum power point tracking: MPPT) or the like, or a voltage set by a current controller, hereinafter referred to as a “set output voltage”) being used as a reference, by a repeating operation (chopper operation) of the alternating conduction and cut-off of the switching means M1, M2, and by a ratio between the set output voltage and the electric power generation voltage (boosting ratio is [set output voltage]/[electric power generation voltage]) being regulated. As is apparent from the drawing, in this case, the voltage Vout between the output terminals is applied to the switching means M1, M2 executing the chopper operation. In FIG. 6B and FIG. 6C, a diode is used in the switching means M2 in some cases.

The circuit configuration according to the aspect described above is the two-stage boosting chopper circuit configuration in which the boosting chopper circuit to which the photovoltaic cell is connected and the boosting chopper circuit to which no photovoltaic cell is connected are connected in series as described above and the case of this configuration is similar to the related art in that the boosting ratio is regulated with the set output voltage being used as a reference but, when the repeating operation (chopper operation) of the alternating conduction and cut-off of the switching means and the additional switching means is executed as in the aspect described above in the case of this configuration, a differential voltage between the set output voltage and the electric power generation voltage of the photovoltaic cell is held by the additional capacitor when the set output voltage is higher than the electric power generation voltage of the photovoltaic cell as will be described in more detail in the following embodiment column. Then, each of the voltages applied to the switching means and the additional switching means performing the chopper operation becomes the electric power generation voltage of the photovoltaic cell or a holding voltage of the additional capacitor and can become lower than the output voltage between the output terminals. In other words, because the output voltage is distributed and assigned to the switching means and the additional switching means, the applied voltage of the switching means and the additional switching means can become relatively lower than in the case of the converter circuit according to the related art as is exemplified in FIG. 6B and FIG. 6C, and thus the loss that occurs therein can be reduced.

In the aspect of the disclosure, the heights of the electric power generation voltage of the photovoltaic cell that is regulated by the chopper operation of the switching means and the additional switching means and the holding voltage of the additional capacitor may be determined based on the ratios of the time width of the conduction cut-off to predetermined cycles of the switching means and the additional switching means (OFF time duty ratios). When the output voltage between the output terminals is a voltage that is higher than the electric power generation voltage of the photovoltaic cell, the OFF time duty ratios of the switching means and the additional switching means may respectively become the ratio of the electric power generation voltage of the photovoltaic cell to the output voltage between the pair of output terminals and the ratio of the holding voltage of the additional capacitor (voltage difference obtained by the electric power generation voltage of the photovoltaic cell being subtracted from the output voltage) to the output voltage between the pair of output terminals as will be described in the following embodiment column (the holding voltage of the additional capacitor may be 0 when the output voltage between the output terminals is equal to the electric power generation voltage of the photovoltaic cell and, in this case, the additional switching means has an OFF time duty ratio of 0). Accordingly, when the output voltage between the pair of output terminals is a voltage that is higher than the electric power generation voltage of the photovoltaic cell in the configuration according to the aspect of the disclosure described above, the conduction and conduction cut-off in the switching means and the additional switching means may be controlled such that the ratio of the time width of the cut-off of the conduction between the pair of connected electrode connection terminals to the predetermined cycle of the switching means is the ratio of the electric power generation voltage of the photovoltaic cell to the output voltage between the pair of output terminals and the ratio of the time width of the cut-off of the conduction between the connected electrode connection terminal and one of the output terminals to the predetermined cycle of the additional switching means is the ratio of the voltage difference obtained by the electric power generation voltage of the photovoltaic cell being subtracted from the output voltage between the pair of output terminals to the output voltage between the pair of output terminals.

In addition, the generated electric power that is extracted from the photovoltaic cell is maximized when the photovoltaic cell performs the electric power generation at the electric power generation voltage at the maximum electric power point. In the case of the device according to the disclosure, the setting of the switching means and the additional switching means allows as described above the voltage to be added to the electric power generation voltage of the photovoltaic cell to be set as desired in the output voltage between the output terminals. Accordingly, once the ratio of the time width of the cut-off of the conduction between the pair of connected electrode connection terminals to the predetermined cycle of the switching means is set as the ratio of the electric power generation voltage at the maximum electric power point of the photovoltaic cell to the output voltage after the set output voltage is set to a certain desired voltage, a state where the photovoltaic cell performs the electric power generation at the electric power generation voltage at the maximum electric power point is realized. Accordingly, in the device according to the disclosure, the output voltage between the pair of output terminals may be a desired voltage and the ratio of the time width of the cut-off of the conduction between the pair of connected electrode connection terminals to the predetermined cycle of the switching means may be set as the ratio of the electric power generation voltage at the maximum electric power point of the photovoltaic cell to the output voltage.

In general photovoltaic electric power generation systems, it is preferable in the case of a change in the environmental conditions of the photovoltaic cell such as the light reception amount and temperature that the electric power generation voltage of the photovoltaic cell can be regulated in real time in response to the change. In many cases, the voltage of the MPPT controller or the current controller is configured to monitor the generated electric power of the photovoltaic cell in a sequential manner and regulate the electric power generation voltage. In the device according to the disclosure, the electric power generation voltage of the photovoltaic cell may be similarly regulated in a sequential manner. In this regard, in the case of the device according to the disclosure, the electric power generation voltage of the photovoltaic cell is regulated based on the ratio of the time width of the cut-off of the conduction between the pair of connected electrode connection terminals to the predetermined cycle of the switching means connected in parallel thereto as described above. Accordingly, means for regulating the ratio of the time width of the cut-off of the conduction between the pair of connected electrode connection terminals to the predetermined cycle of the switching means such that the electric power generation voltage of the photovoltaic cell becomes the voltage at the maximum electric power point may be additionally disposed in the device according to the disclosure. This means may be configured to appropriately change the ratio of the time width of the cut-off of the conduction between the pair of connected electrode connection terminals to the predetermined cycle of the switching means such that the generated electric power is maximized based on a change in the generated electric power that is monitored in the voltage of the MPPT controller or the current controller which regulates the output voltage between the pair of output terminals.

In general, the current at the maximum electric power point changes to a significant extent but the height of the electric power generation voltage does not change that much in the photovoltaic cell as is apparent from FIG. 6A. Accordingly, in a case where the plurality of photovoltaic cells are connected in parallel, the heights of the electric power generation voltages substantially correspond to each other even if the maximum electric power points differ from each other between the plurality of photovoltaic cells, and thus the circuit configuration according to the disclosure allows the electric power generation operation point control and boosting to be executed with respect to the group of the plurality of photovoltaic cells that are connected in parallel. Accordingly, the plurality of photovoltaic cells may be added in parallel between the pair of electrode connection terminals in the configuration according to the disclosure described above. This configuration is advantageous in that the control circuits can be reduced with respect to the same number of photovoltaic cells.

In addition, the electric power generation operation point control circuit devices according to a series of the aspects of the disclosure described above can be used with the plurality of electric power generation operation point control circuit devices being connected in series. Hence, according to another aspect of the disclosure, there is provided the multi-stage electric power generation operation point control circuit device that is formed by the plurality of electric power generation operation point control circuit devices described above being connected in series at the output terminals.

As described above, the electric power generation operation point control circuit device according to the aspect of the disclosure described above is capable of adjusting the electric power generation voltage of the photovoltaic cell to the voltage at the maximum electric power point as a unit in a state where the output voltage between the output terminals is set to any voltage. The current of the photovoltaic cell in this case becomes the current at the maximum electric power point, the current between the output terminals becomes a value obtained by the generated electric power of the photovoltaic cell being divided by the output voltage between the output terminals, and, in short, the difference between the current between the output terminals and the current of the photovoltaic cell flows bypassing the photovoltaic cell based on switching in the switching means and the additional switching means. In other words, in the case of this configuration, the output voltage is variable in a state where the operation point of the photovoltaic cell of the unit electric power generation operation point control circuit device is adjusted to the maximum electric power point and, even in a state where the unit electric power generation operation point control circuit devices are connected in series and the total sum of the output voltages is set as desired, a state where each of the operation points of the photovoltaic cells is adjusted to the maximum electric power point as described above can be realized. In other words, in the multi-stage electric power generation operation point control circuit device according to the disclosure, the photovoltaic cell can perform the electric power generation operation without any generated electric power decline in the state where each of the operation points of the photovoltaic cells is adjusted to the maximum electric power point even if the maximum electric power points of the photovoltaic cells differ from each other in the group of the plurality of photovoltaic cells connected in series and the output voltage of the multi-stage electric power generation operation point control circuit device, that is, the total sum of the output voltages of the respective unit electric power generation operation point control circuit devices can be boosted as desired.

More specifically, in the case of the configuration described above, the respective unit electric power generation operation point control circuit devices have a common output current and the total sum of the generated electric power becomes the total sum of the generated electric power of the respective photovoltaic cells. Accordingly, as will be described later, the output voltages between the output terminals of the unit electric power generation operation point control circuit devices are distributed at the ratio of the generated electric power of the respective photovoltaic cells. In other words, the output voltage of the multi-stage electric power generation operation point control circuit device is the total sum of the output voltages between the pair of output terminals of the plurality of electric power generation operation point control circuit devices connected in series as described above and the output voltages of the unit electric power generation operation point control circuit devices that can be set as desired are distributed at the ratio of the generated electric power of the respective photovoltaic cells, and thus the total sum of the output voltages between the pair of output terminals of the plurality of electric power generation operation point control circuit devices connected in series may be the desired voltage in the end.

It should be noted that each of the unit electric power generation operation point control circuit devices may have a series of the characteristic configurations described above in the multi-stage electric power generation operation point control circuit device described above. In each of the unit electric power generation operation point control circuit devices, the OFF time duty ratios of the switching means and the additional switching means are determined by the voltage among the output voltages of the multi-stage electric power generation operation point control circuit device that is distributed at the ratio of the generated electric power of each photovoltaic cell being used as the output voltage of each unit. In other words, in each unit electric power generation operation point control circuit device of the multi-stage electric power generation operation point control circuit device described above, the ratio of the time width of the cut-off of the conduction between the pair of connected electrode connection terminals to the predetermined cycle of the switching means may be the ratio of the electric power generation voltage of the photovoltaic cell to the output voltage between the pair of output terminals of the unit and the ratio of the time width of the cut-off of the conduction between the connected electrode connection terminal and one of the output terminals to the predetermined cycle of the additional switching means may be the ratio of the voltage difference obtained by the electric power generation voltage of the photovoltaic cell being subtracted from the output voltage between the pair of output terminals to the output voltage between the pair of output terminals of the unit when the output voltage between the pair of output terminals of the unit is a voltage that is higher than the electric power generation voltage of the photovoltaic cell and the ratio of the time width of the cut-off of the conduction between the pair of connected electrode connection terminals to the predetermined cycle of the switching means may be set as the ratio of the electric power generation voltage at the maximum electric power point of the photovoltaic cell to the output voltage of the unit. It should be noted that the plurality of photovoltaic cells may be connected in parallel between the pair of electrode connection terminals in each of the unit electric power generation operation point control circuit devices.

In addition, the external response switching means for connecting the output terminals of the adjacent ones of the plurality of electric power generation operation point control circuit devices connected in series to each other to be capable of conduction and cutting off the conduction between the output terminals connected to be capable of the conduction in response to the signal from the outside may also be disposed in the multi-stage electric power generation operation point control circuit device according to the aspect of the disclosure described above. The signal from the outside may be, for example, a signal that is emitted once the occurrence of a situation in which the electric power generation operation of the photovoltaic cell should be stopped is detected in the facility or the vehicle where the multi-stage electric power generation operation point control circuit device is mounted. According to this configuration, the conduction in the external response switching means is cut off based on the signal from the outside in a case where the electric power generation operation of the photovoltaic cell is to be stopped, and thus the photovoltaic cell can promptly stop the voltage application between the output terminals of the multi-stage electric power generation operation point control circuit device (between the output terminals of the electric power generation operation point control circuit devices at both ends). In a case where the photovoltaic cells are connected in series, the total sum of the electric power generation voltages is higher than in the case of the unit photovoltaic cell, and thus the output voltage rises to a significant extent in some cases. Accordingly, the multi-stage electric power generation operation point control circuit device according to the aspect of the disclosure is advantageous in that a state of high output voltage application can be promptly dealt with through the signal from the outside in a case where, for example, the situation in which the electric power generation operation of the photovoltaic cell should be stopped occurs in the facility or the vehicle where the multi-stage electric power generation operation point control circuit device is mounted.

Accordingly, in the electric power generation operation point control circuit device (unit) according to the aspect of the disclosure described above, the voltage that is applied to the switching means is relatively reduced in comparison to the converter circuit according to the related art which has a similar function as described above, and thus the loss in the switching means is reduced. In addition, in the electric power generation operation point control circuit device (unit) according to the aspect of the disclosure described above, the applied voltage is reduced, and thus switching means with a low allowable withstand voltage can also be selected as the switching means to be adopted. Furthermore, in the multi-stage electric power generation operation point control circuit device according to the disclosure described above, the electric power generation operation of the photovoltaic cell can be performed in the state where the respective operation points of the photovoltaic cells are adjusted to the maximum electric power points in the group of the plurality of photovoltaic cells connected in series as described above and the output voltage of the multi-stage electric power generation operation point control circuit device can be boosted as well. In this regard, a similar function is achieved even in the case of the electric power generation operation point control circuit device according to the related art insofar as the converter circuit is connected to the output terminal but, in this case, those with higher allowable withstand voltages are required as the switching means and the inductor used in the converter circuit because the boosting is executed with respect to the output voltage of the electric power generation operation point control circuit, that is, the total sum of the electric power generation voltages of the photovoltaic cells. Moreover, in the electric power generation operation point control circuit according to the related art, the OFF time duty ratio of each of the switching means becomes the ratio of the electric power generation voltage of each photovoltaic cell to the output voltage, and thus the complexity of a processing for adjusting the electric power generation voltages of all the photovoltaic cells to the maximum electric power points might increase. In contrast, in the case of the multi-stage electric power generation operation point control circuit device according to the disclosure, the OFF time duty ratio of each of the switching means is adjustment of the ratio of the electric power generation voltage of the photovoltaic cell to the distributed voltage, and thus the multi-stage electric power generation operation point control circuit device according to the disclosure is advantageous in that the processing for adjusting the electric power generation voltage of the photovoltaic cell to the maximum electric power point is relatively facilitated although the multi-stage electric power generation operation point control circuit device according to the disclosure is subjected to an increase in the number of components.

It should be noted that the disclosure may be applied for a circuit that plurality of the photovoltaic cells are connected in series.

What is claimed is:

1. An electric power generation operation point control circuit device comprising:
a pair of output terminals;
a pair of electrode connection terminals connected to an electrode terminal of a photovoltaic cell between the pair of output terminals;
a first capacitor connected in parallel to the photovoltaic cell via the pair of electrode connection terminals between the pair of output terminals;
an inductor;
a first switching element connected in parallel to the photovoltaic cell via the pair of electrode connection terminals and the inductor between the pair of output terminals and causing a conduction state or a non-conduction state between the connected terminals;
a second capacitor connected in series to the first capacitor between a first electrode connection terminal and a first output terminal and causing the conduction state or the non-conduction state between the connected terminals, the first electrode connection terminal being one of the pair of electrode connection terminals and the first output terminal being one of the output terminals;
a second switching element connected in parallel to the second capacitor and connected in series to the first switching element; and
a calculation device configured to control the first switching element and the second switching element in an alternating manner at a predetermined cycle such that the second switching element is put into the non-conduction state when the first switching element is in the conduction state and the second switching element is put into the conduction state when the first switching element is in the non-conduction state.

2. The electric power generation operation point control circuit device according to claim 1,
wherein a ratio of a time width of putting the first switching element into the non-conduction state to the predetermined cycle is a ratio of an electric power generation voltage of the photovoltaic cell to an output voltage between the pair of output terminals and a ratio of a time width of putting the second switching element into the non-conduction state to the predetermined cycle is a ratio of a voltage difference obtained by the electric power generation voltage of the photovoltaic cell being subtracted from the output voltage between the pair of output terminals to the output voltage between the pair of output terminals when the output voltage between the pair of output terminals is a voltage higher than the electric power generation voltage of the photovoltaic cell.

3. The electric power generation operation point control circuit device according to claim 2,
wherein the output voltage between the pair of output terminals is a desired voltage, and
wherein the ratio of the time width of putting the first switching element into the non-conduction state to the predetermined cycle is a ratio of the electric power generation voltage at a maximum electric power point of the photovoltaic cell to the output voltage.

4. The electric power generation operation point control circuit device according to claim 3,
wherein the calculation device is configured to regulate the ratio of the time width of putting the first switching element into the non-conduction state to the predetermined cycle such that the electric power generation voltage of the photovoltaic cell becomes the voltage at the maximum electric power point.

5. The electric power generation operation point control circuit device according to claim 1,
wherein a plurality of the photovoltaic cells are connected in parallel between the pair of electrode connection terminals.

6. A multi-stage electric power generation operation point control circuit device,
wherein the electric power generation operation point control circuit device according to claim 1 is connected in series to the output terminal.

7. The multi-stage electric power generation operation point control circuit device according to claim 6,
wherein a total sum of output voltages between the pair of output terminals of a plurality of the electric power generation operation point control circuit devices connected in series is a desired voltage.

8. The multi-stage electric power generation operation point control circuit device according to claim 6,
wherein a third switching element is additionally disposed, the third switching element connecting the output terminals of adjacent devices among a plurality of the electric power generation operation point control circuit devices connected in series to each other to be capable of conduction and cutting off the conduction between the output terminals connected to be capable of the conduction in response to a signal from an outside.

9. The multi-stage electric power generation operation point control circuit device according to claim 8,
wherein the signal from the outside is a signal emitted when occurrence of a situation in which an electric power generation operation of the photovoltaic cell is to be stopped in a facility or a vehicle where the multi-stage electric power generation operation point control circuit device is mounted is detected.
